(19) United States
(12) Patent Application Publication
(10) Pub. No.: US 2008/0061689 A1
(43) Pub. Date: Mar. 13, 2008

(54) DIELECTRIC BARRIER DISCHARGE LAMP DEVICE AND BACKLIGHT FOR LIQUID CRYSTAL DISPLAY

(75) Inventors: Kazuaki OHKUBO, Osaka (JP); Satoshi KOMINAMI, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/928,148

(22) Filed: Oct. 30, 2007

Related U.S. Application Data
(63) Continuation of application No. PCT/JP2007/051795, filed on Feb. 2, 2007.

(30) Foreign Application Priority Data
Feb. 13, 2006 (JP) 2006-034814

(51) Int. Cl. H01J 1/62

(52) U.S. Cl. 313/509

(57) ABSTRACT

A dielectric barrier discharge lamp device is provided with a glass tube filled with a discharge medium; a pair of internal electrodes arranged on the both ends in the glass tube, respectively, an external electrode arranged outside the glass tube, a ballast circuit connected to the pair of internal electrodes and the external electrode, and a diode connected between only one of the internal electrodes and the ballast circuit.

### TECHNICAL FIELD

The present invention relates to a dielectric barrier discharge lamp device, and in particular to a dielectric barrier discharge lamp device used as a backlight for a liquid crystal display.

### BACKGROUND ART

In a recent trend of wider screen and smaller thickness of a video display, there is an increasing demand for higher performance of a liquid crystal display (LCD). As a light source for a backlight which is a component of the LCD, a cold cathode fluorescent lamp has been used, but from the viewpoint of environmental protection, a mercury-free light source is being expected. To meet this demand, a dielectric barrier discharge lamp capable of achieving a high efficiency without using mercury is being developed.

In the dielectric barrier discharge lamp, a technology capable of enhancing the brightness and luminance and improving uniformity of luminance in the tube axis direction has been proposed (see patent document 1).

FIG. 7A shows a configuration of a driving device of a Xenon fluorescent discharge lamp as an example of a dielectric barrier discharge lamp disclosed in patent document 1. The Xenon fluorescent lamp includes a fluorescent discharge tube 10 filled with a rare gas, internal electrodes 13 and 13′ disposed inside of the fluorescent discharge tube 10, an external electrode 15 disposed outside of the fluorescent discharge tube 10, a power supply 18 connected to the internal electrodes 13 and 13′ and external electrode 15, and diodes 19 and 29 connected between each of internal electrodes 13 and 13′ and the power supply (ballast circuit) 18. The diodes 29 and 19 are disposed in such a direction that the currents flowing into the internal electrodes 13 and 13′ may be different in polarity. These diodes 29 and 19 makes a current of negative polarity flow into the internal electrode 13 and a current of positive polarity flow into the internal electrode 13′, every time the polarity of rectangular wave of the power source 18 is inverted. As a result, the entire fluorescent discharge tube 10 emits light while decreasing the overall uniformity of luminance of the fluorescent discharge tube 10, thus enhancing the luminance.
** Patent Document 1: JP-A-11-214184 (see par. [0018], FIG. 2C and so on)

### DISCLOSURE OF INVENTION

### Problem to be Solved

However, in the configuration in which the diodes 29 and 19 are connected between the internal electrodes 13 and 13′ and power supply 18 as disclosed in patent document 1, it is found that the start-up performance may be inferior depending on the location of the external electrode 15, structure of fluorescent discharge tube 10, or a voltage applied between the internal electrodes 13 and 13′ and external electrode 15.

Additionally, in the configuration of patent document 1, although uniformity of luminance is improved on the whole, momentarily the discharge takes place only between one of internal electrodes and external electrode, thus resulting in a dark area remaining in the center.

The invention is directed to solve the problems of the prior art, and it is hence an object thereof to provide a dielectric barrier discharge lamp device capable of assuring the starting performance and reducing the uniformity of luminance.

### Means of Solving Problems

To solve the problems described above, a dielectric barrier discharge lamp device according to the invention includes a glass tube filled with a discharge medium, a pair of internal electrodes disposed at both ends of the inside of the glass tube, an external electrode disposed outside of the glass tube, a ballast circuit connected to the pair of internal electrodes and the external electrode, and a diode connected between either one of the pair of internal electrodes and the ballast circuit.

The discharge medium may be a rare gas and includes no mercury.

A backlight for a liquid crystal display according to the invention includes a glass tube filled with a discharge medium, a pair of internal electrodes disposed at both ends of the inside of the glass tube, an external electrode disposed outside of the glass tube, a ballast circuit connected to the pair of internal electrodes and the external electrode, and a diode connected between either one of the pair of internal electrodes and the ballast circuit.

### EFFECTS OF THE INVENTION

According to the invention, the dielectric barrier discharge lamp device is configured so that a diode is connected to one of a pair of internal electrodes disposed at both ends of the inside of the lamp and a voltage is applied to the diode from the ballast circuit. As a result, a uniform luminance distribution is realized, and the starting performance when lighting the lamp can be improved at the same time.

### BRIEF DESCRIPTION OF DRAWINGS

FIG. 1A is a diagram of a configuration of a dielectric barrier discharge lamp device in an embodiment of the invention.

FIG. 1B is an explanatory diagram of a lamp current occurring when a higher voltage is applied to an internal electrode with respect to a potential of an external electrode in the dielectric barrier discharge lamp device of the invention.

FIG. 1C is an explanatory diagram of a lamp current occurring when a lower voltage is applied to an internal electrode with respect to a potential of an external electrode in the dielectric barrier discharge lamp device of the invention.

FIG. 2A is a diagram of a configuration of a dielectric barrier discharge lamp device in a prior art as a comparative example.

FIG. 2B is an explanatory diagram of a lamp current occurring when a higher voltage is applied to an internal electrode with respect to a potential of an external electrode in the dielectric barrier discharge lamp device of the prior art.

FIG. 2C is an explanatory diagram of a lamp current occurring when a lower voltage is applied to an internal electrode with respect to a potential of an external electrode in the dielectric barrier discharge lamp device of the prior art.

FIG. 3 is a waveform diagram of a lamp voltage of the dielectric barrier discharge lamp device of the prior art.

FIG. 4 is a waveform diagram of a lamp voltage of the dielectric barrier discharge lamp device according to an embodiment of the invention.

FIG. 5 is a luminance distribution diagram of the dielectric barrier discharge lamp devices of the invention and the prior art.

FIG. 6 is a diagram of a configuration of the dielectric barrier discharge lamp device of a prior art as a comparative example.

FIG. 7A is a diagram of a configuration of a dielectric barrier discharge lamp device of the prior art.

FIG. 7B is an explanatory diagram of a lamp current occurring when a higher voltage is applied to an internal electrode with respect to a potential of an external electrode in the dielectric barrier discharge lamp device of the prior art

FIG. 7C is an explanatory diagram of a lamp current occurring when a lower voltage is applied to an internal electrode with respect to a potential of an external electrode in the dielectric barrier discharge lamp device of the prior art.

### REFERENCE SIGNS

100 Dielectric barrier discharge lamp device of the invention
200, 300, 800 Dielectric barrier discharge lamp device of prior art
10 Glass tube
13, 13′ Internal electrode
15 External electrode
18 Ballast circuit
19, 29 Diode

### Best Mode for Carrying Out the Invention

Preferred embodiments of the invention are described below with reference to the accompanying drawings.

1. Configuration of Dielectric Barrier Discharge Lamp Device

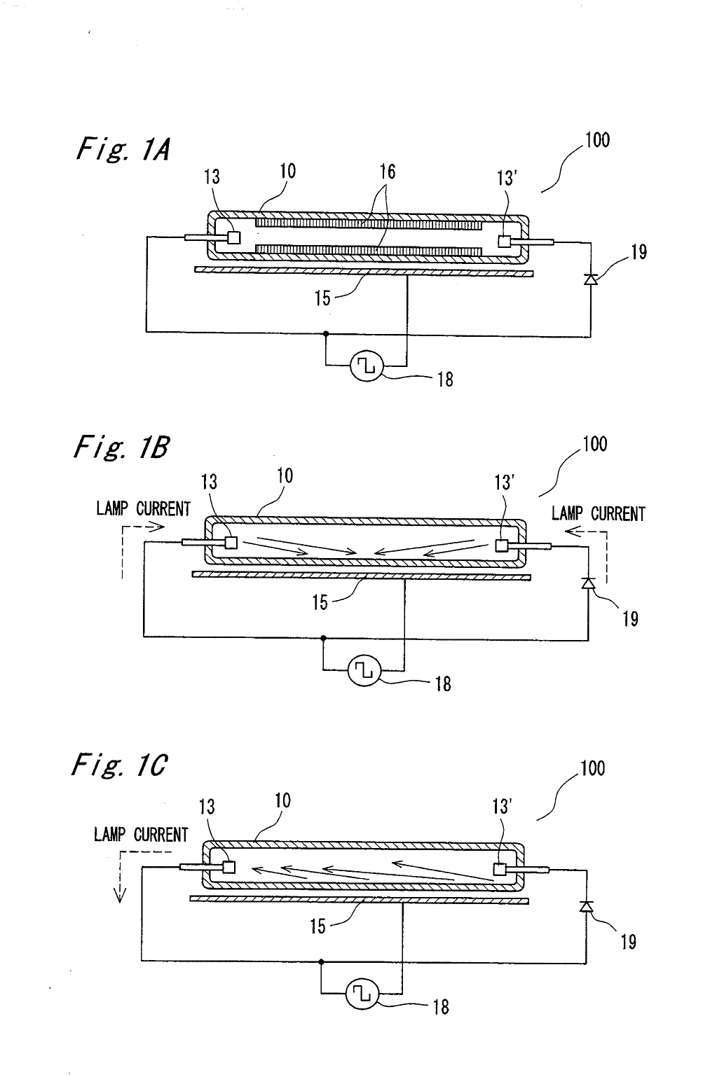

FIG. 1A shows a configuration of a dielectric barrier discharge lamp device according to the embodiment of the invention. The dielectric barrier discharge lamp device 100 includes a dielectric barrier discharge lamp having a glass tube 10 filled with a discharge medium, and a ballast circuit 18.

The dielectric barrier discharge lamp has a pair of internal electrodes 13 and 13′ disposed at both ends of the inside of the glass tube 10. An external electrode 15 is disposed outside of the glass tube 10. The inside of the glass tube 10 is applied with a phosphor layer 16. The internal electrodes 13 and 13′ and external electrode 15 are connected to the ballast circuit 18. In this embodiment, in particular, a diode 19 is connected between the internal electrode 13′ (which is one of internal electrodes 13 and 13′) and the ballast circuit 18. Each element is specifically described below.

The glass tube 10 is generally a mass-producible, strong and thin tube. The material for the glass tube 10 may be borosilicate glass, quartz glass, soda glass, lead glass or other glass materials. The outside diameter of the glass tube 10 is generally about 1.0 to 10.0 mm, but is not limited to that value. For example, it may be about 30 mm as used for a general fluorescent lamp. The glass tube 10 is not limited to straight shape, but may have L-figure, U-figure, rectangular and other shapes. The length of the glass tube 10 is preferably 50 mm to 1000 mm.

The glass tube 10 is sealed and filled with a discharge medium (not shown). The discharge medium includes at least one kind of gas mainly composed of a rare gas. In the dielectric barrier discharge, preferably, mercury may not be contained. The pressure of the filled gas, that is, the inside pressure of the glass tube 10 is about 0.1 kPa to 76.0 kPa.

The internal electrodes 13 and 13′ are formed of tungsten, nickel or other metal. Part or whole of the surface of internal electrodes 13 and 13′ may be coated with metal oxide layer such as cesium oxide, barium oxide, or strontium oxide. Such metal oxide layer can reduce the discharge start voltage and prevent deterioration of electrodes due to ion bombardment.

The external electrode 15 is disposed across a gap from the glass tube 10. By allowing a gap of a proper distance, insulation breakdown occurring between the external electrode 15 and the surface of glass tube 10 can be prevented (see, for example, paragraphs [0053], [0092], and others of the gazette of International Publication No. WO2005/022586). Meanwhile, if not necessary to consider prevention of insulation breakdown occurring between the external electrode 15 and glass tube 10, the external electrode 15 may contact with the glass tube 10. The external electrode 15 may be formed of transparent conductive structure mainly composed of copper, aluminum, stainless steel, other metal, tin oxide, or indium oxide. Use of the reflexible external electrode 12 can achieve high efficiency reflection of a light from the glass tube 10 to the external electrode 12, realizing a high light output efficiency, without providing a high reflection sheet between the external electrode 12 and emitting grass tube 10.

The phosphor layer 16 is formed for converting a wavelength of a light emitted from the discharge medium. Lights of various wavelengths can be obtained by changing the material of the phosphor layer 16. For example, a white, red, green or blue light can be obtained. The phosphor layer 16 is formed of any material used in general fluorescent lamps, plasma display panel, and so on.

The ballast circuit 18 applies a voltage of rectangular wave between the internal electrodes 13 and 13′ and external electrode 15. In the case of dielectric barrier discharge, it is generally preferred to apply a voltage in rectangular wave because the lamp efficiency (the value of the output luminous flux from the glass tube 10 divided by the supplied power to the glass tube 10) is enhanced. As the rectangular wave voltage is applied by the ballast circuit 18, dielectric barrier discharge occurs through the tube wall of the glass tube 10, causing light emission. The peak-to-peak value Vp-p of the rectangular wave voltage applied by the ballast circuit 18 is preferred to be 1 kV to 10 kV.

The diode 19 is connected in a direction so that a current flows from the ballast circuit 18 to the internal electrode 13′.

2. Lighting Operation

The ballast circuit 18 applies a rectangular wave voltages changing at a specified frequency between the internal electrodes 13 and 13′ and external electrode 15. When a voltage of positive polarity is applied to the internal electrodes 13 and 13′ with respect to a potential of the external electrode 15, that is, when a forward bias is applied to the diode 19, as shown in FIG. 1B, discharge occurs and a lamp current flows in a direction from the internal electrodes 13 and 13′ to the external electrode 15. On the other hand, when a voltage of negative polarity is applied to the internal electrodes 13 and 13′ with respect to the potential of the external electrode 15, that is, when a reverse bias is applied to the diode 19, as shown in FIG. 1C, the lamp current flows only in a direction from the external electrode 15 to the internal electrode 13, and no lamp current flows into the internal electrode 13′.

Thus, the dielectric barrier discharge lamp device 100 of the embodiment is arranged so that, when the ballast circuit 18 applies a driving voltage in forward bias to the diode 19, the current flows in both internal electrodes 13 and 13′, but when a driving voltage in reverse bias is applied to the diode 19, the current flows only in the internal electrode 13. This arrangement can realize a uniform luminance distribution, and further improve the starting performance as described below.

3. Measurements of Starting Performance Test

The measurements of the starting performance test of the dielectric barrier discharge lamp device 100 shown in FIG. 1A is described below.

In the starting performance test, the dielectric barrier discharge lamp device 100 are set in the following conditions. The glass tube 10 is 700 mm in length, 3 mm in outside diameter, and 2 mm in inside diameter. The discharge medium filled in the glass tube 10 is xenon gas at 16 kPa. A total of 24 glass tubes 10 are disposed and spaced at intervals of 16 mm. The external electrode 15 is a member with 16 mm in width and 700 mm in length, made of aluminum and having a parabolic shape of f=4.6 mm. The external electrode 15 is disposed at each one of the twenty-four glass tubes 10. These glass tubes 10 are arranged so that the central axes of the glass tubes 10 may cross on the focal position of the parabolic plane of the external electrode 15. The distance between the external electrode 15 and glass tube 10 is 3 mm. The voltage applied from the ballast circuit 18 is a rectangular wave of frequency of 20.4 kHz, and voltage V0-p from 0 V to peak voltage is the rated value of 1.7 kV. The voltage V0-p is variable in allowable range of the ballast circuit 18. A high-voltage rectifier diode manufactured by Sanken Electric Co., Ltd. (model No.:Ux-F5B) is used for the diode 19.

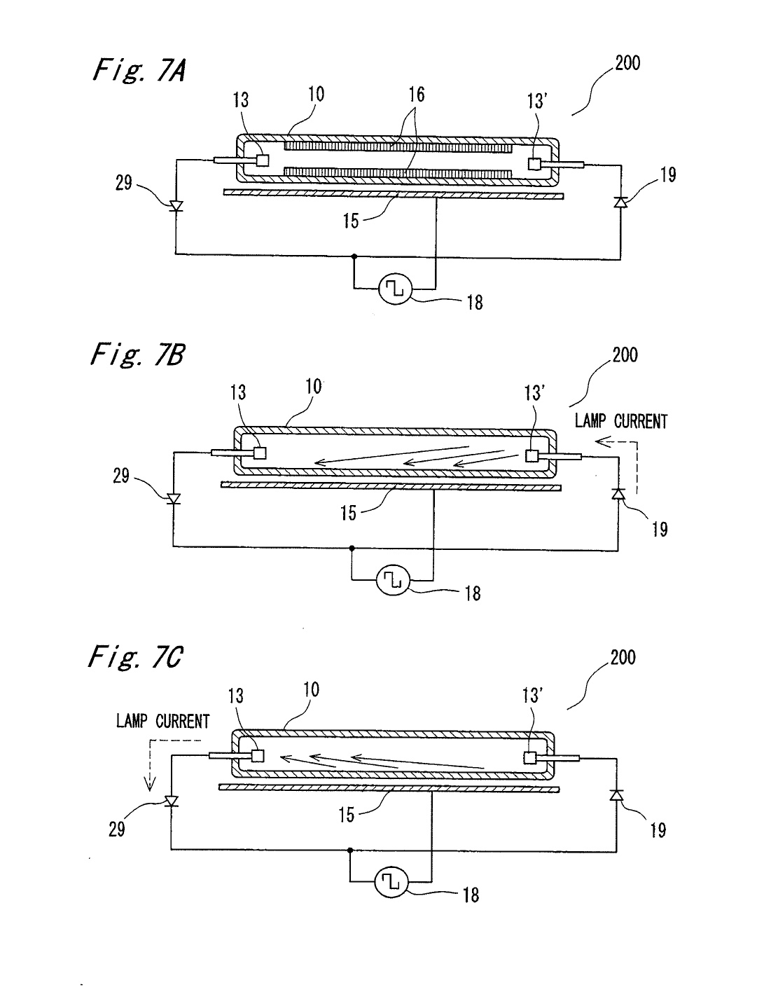

As a comparative example of the dielectric barrier discharge lamp device 100 of the invention, the starting performance is similarly tested for the conventional dielectric barrier discharge lamp device 200 disclosed in patent document 1 as shown in FIG. 7A. The dielectric barrier discharge lamp device 200 differs from the dielectric barrier discharge lamp device 100 in that diodes 19 and 29 are disposed between the both internal electrodes 13 and 13′ and the ballast circuit 18. The other configuration is same as in the dielectric barrier discharge lamp device 100, and the same parts are identified with the same reference numerals, and explanation thereto is omitted. The connection of the diode 29 is made so that the current may flow in forward direction from the internal electrodes 13 to the ballast circuit 18.

In the dielectric barrier discharge lamp device 200 shown in FIG. 7A, the lamp current flows as follows. That is, when a voltage of positive polarity is applied to the internal electrodes 13 and 13′ with respect to the potential of the external electrode 15, that is, when a forward bias is applied to the diode 19 and a reverse bias is applied to the diode 29, as shown in FIG. 7B, the lamp current flows to the external electrode 15 only from the internal electrode 13′ but does not flow from the internal electrode 13. By contrast, when a voltage of negative polarity is applied to the internal electrodes 13 and 13′ with respect to the potential of the external electrode 15, that is, when a reverse bias is applied to the diode 19 and a forward bias is applied to the diode 29, as shown in FIG. 7C, the lamp current flows from the external electrode 15 only to the internal electrode 13 but does not flow to the internal electrode 13′.

The starting performance of the dielectric barrier discharge lamp device 100 of the invention and dielectric barrier discharge lamp device 200 of the comparative example was evaluated by changing the voltage Vo-p applied between the internal electrodes 13 and 13′ and external electrode 15. The results are shown in Table 1.

TABLE 1

Voltage between internal
electrode and external
electrode V0-p [kV]

| | 1.75 | 2.00 |
|---|---|---|
| <Invention> | Lighting | Lighting |
| Dielectric barrier discharge | | |
| lamp (100) | | |
| <Comparison Example> | Not lighting | Not lighting |
| Dielectric barrier discharge | | |
| lamp (200) | | |

As known from Table 1, the dielectric barrier discharge lamp device 100 of the invention starts (lights up) at V0-p of 1.75 kV, while the conventional dielectric barrier discharge lamp device 200 does not start (does not light up) even if Vo-p is raised to 2.00 kV.

Therefore, as compared with the conventional dielectric barrier discharge lamp device 200 having the respective diodes 19 and 29 connected between the internal electrodes 13 and 13′ and the ballast circuit 18, it is known that the starting performance is improved by connecting the diode 19 between only one internal electrode 13′ of a pair of internal electrodes 13 and 13′ and the ballast circuit 18. In the embodiment, the reason why the test was not executed with V0-p exceeding 2.00 kV is because it is beyond the allowable range of the ballast circuit 18. That is, the conventional dielectric barrier discharge lamp 200 having diodes connected to both internal electrodes 13 and 13′ shown in FIG. 7 does not light in a usual allowable voltage range of a backlight for a liquid crystal display.

3.1 Discussion of Starting Characteristic

The mechanism that the dielectric barrier discharge lamp device 100 of the invention is improved in the starting performance and the conventional dielectric barrier discharge lamp device 200 is not started is described below.

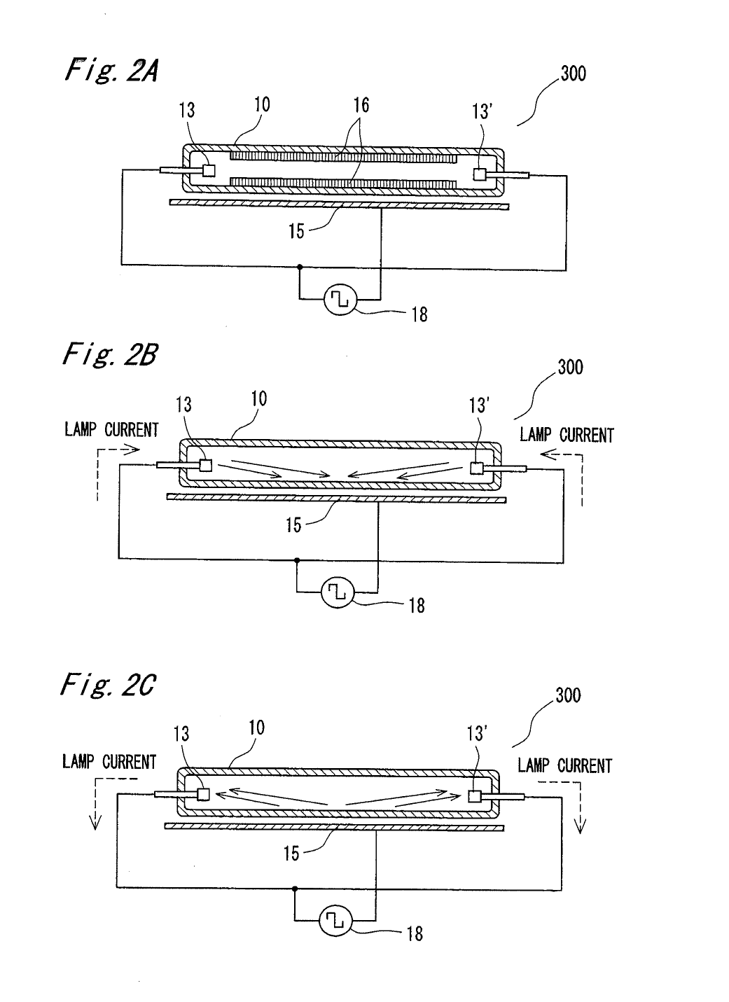

First, prior to discussion of the dielectric barrier discharge lamp device 200, another conventional example, as shown in FIG. 2A, of a dielectric barrier discharge lamp device 300 having no diode connected between the internal electrodes 13 and 13′ and ballast circuit 18 is discussed below. The dielectric barrier discharge lamp device 300 is different from that as shown in FIG. 1A in that the diode 19 is not inserted.

In the dielectric barrier discharge lamp device 300 shown in FIG. 2A, the lamp current flows as follows. That is, when a voltage of positive polarity is applied to the internal electrodes 13 and 13′ with respect to the potential of the external electrode 15, the lamp current flows to the external electrode 15 from the internal electrodes 13 and 13′ as shown in FIG. 2B. By contrast, when a voltage of negative polarity is applied to the internal electrodes 13 and 13′ with respect to the potential of the external electrode 15, the lamp current flows to the internal electrode 13 from the external electrode 15 as shown in FIG. 2C.

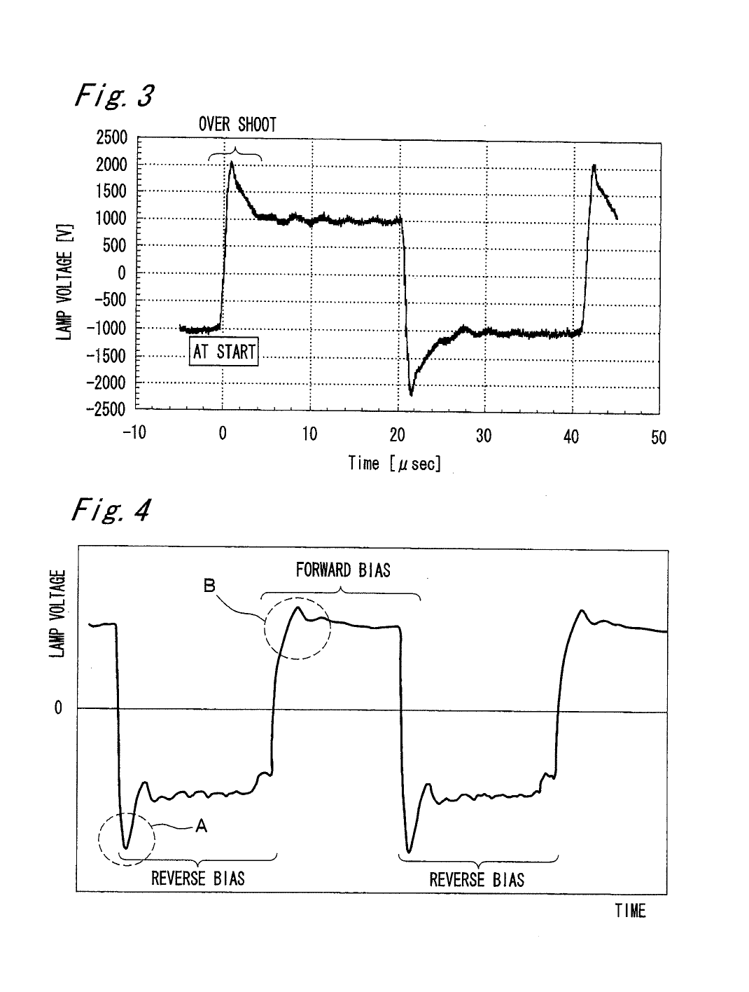

FIG. 3 shows measurements of a lamp voltage waveform of the dielectric barrier discharge lamp device 300 shown in FIG. 2A. As known from FIG. 3, the measured lamp voltage waveform is not an ideal rectangular wave, but includes voltage overshoot occurring right after changeover of polarity of the rectangular wave. The overshoot is a phenomenon caused by resonance of leakage inductance of a step-up transformer in the ballast circuit 18 and parasitic capacity of the step-up transformer. Occurrence of overshoot causes a high voltage momentarily exceeding the discharge start voltage in the dielectric barrier discharge lamp, thereby leading to discharge.

FIG. 4 shows a lamp voltage waveform of dielectric barrier discharge lamp device 100 of the invention. FIG. 4 shows waveforms occurring when a reverse bias and a forward bias are applied to the diode 19. As known from FIG. 4, when a reverse bias is applied to the diode 19, the overshoot of lamp voltage (part “A” in FIG. 4) occurs, but in part “B” at which a reverse bias is changed over to a forward bias, the overshoot has disappeared.

It is generally known that, in a diode, a depletion layer exists in the boundary of P-type semiconductor and N-type semiconductor, and the depletion layer functions as capacitor. It is estimated that when a capacitor formed by the depletion layer of the diode 19 changes over the lamp voltage applied to the diode 19 from a reverse bias to a forward bias for the diode 19, the overshoot is eliminated as shown in part “B” in FIG. 4.

In consideration of this phenomenon, the reason why the dielectric barrier discharge lamp device 200 shown in FIG. 7A fails to start as shown in Table 1 is estimated. The conventional dielectric barrier discharge lamp device 200 has the diodes 19 and 29 which are connected to the internal electrodes 13′ and 13, respectively. Hence, in the conventional dielectric barrier discharge lamp device 200, due to capacity component of the depletion layer of the diodes, when voltages of positive polarity and negative polarity are applied to the internal electrodes 13 and 13′, the overshoot of lamp voltage waveform is eliminated. By contrast, in the dielectric barrier discharge lamp device 100 of the invention, since the diode 19 is connected only to one internal electrode 13′, only when a voltage of positive polarity is applied to the internal electrodes 13 and 13′, the overshoot of lamp voltage waveform is eliminated. Thus, in the case of conventional dielectric barrier discharge lamp device 200, as compared with the dielectric barrier discharge lamp device 100 of the invention, the peak voltage of lamp voltage waveform is suppressed more significantly. Hence it is estimated that the starting performance is inferior as shown in Table 1.

The starting performance is inferior when the lamp capacity CL (capacity determined by a gap between the glass tube 10 and external electrode 15) is smaller. This can be explained as follows. Suppose a capacitor (CL) formed between the internal electrode 13 and external electrode 15 is composed of a series connection of “a capacitor C1 formed of discharge space causing insulation breakdown” and “a capacitor C2 formed of the glass tube 10 and the gap”. As the gap increases, the capacity of the capacitor C2 becomes smaller. When the capacity of the capacitor C2 becomes smaller, the voltage applied to the capacitor Cl decreases. Due to this voltage decrease, the voltage applied to the discharge space declines, and insulation breakdown is less likely to occur in the discharge space. Therefore it is known that it needs to apply a greater voltage for the starting between the internal electrode 13 and external electrode 15, when the lamp capacity is small. Hence, it is estimated that the dielectric barrier discharge lamp device with a smaller lamp capacity CL is more likely to be affected by decline of the applied voltage by a virtual capacitor Cd of the diode. Structure having a small lamp capacity CL is provided, for example, by forming a gap between the glass tube 10 and external electrode 15 as in the embodiment, by increasing the thickness of the glass tube 10, or by decreasing an area of the external electrode 15.

As explained herein, according to the invention, the diode 19 is connected between either one of a pair of internal electrodes 13 and 13′ disposed at both ends of the inside of the glass tube 10 and the ballast circuit 18. By this arrangement, when the voltage from the ballast circuit 18 applied between the internal electrodes 13 and 13′ and external electrode 15 is changed from a forward direction to a reverse direction of the diode 19, that is, when a voltage is applied between the internal electrode 13 and external electrode 15, the voltage from the ballast circuit 18 can be applied directly between the internal electrode 13 and external electrode 15 without a voltage drop due to the diode 19, thereby discharging securely the discharge medium to assure a favorable starting performance.

4. Luminance Distribution

Measurements of luminance distribution are explained below.

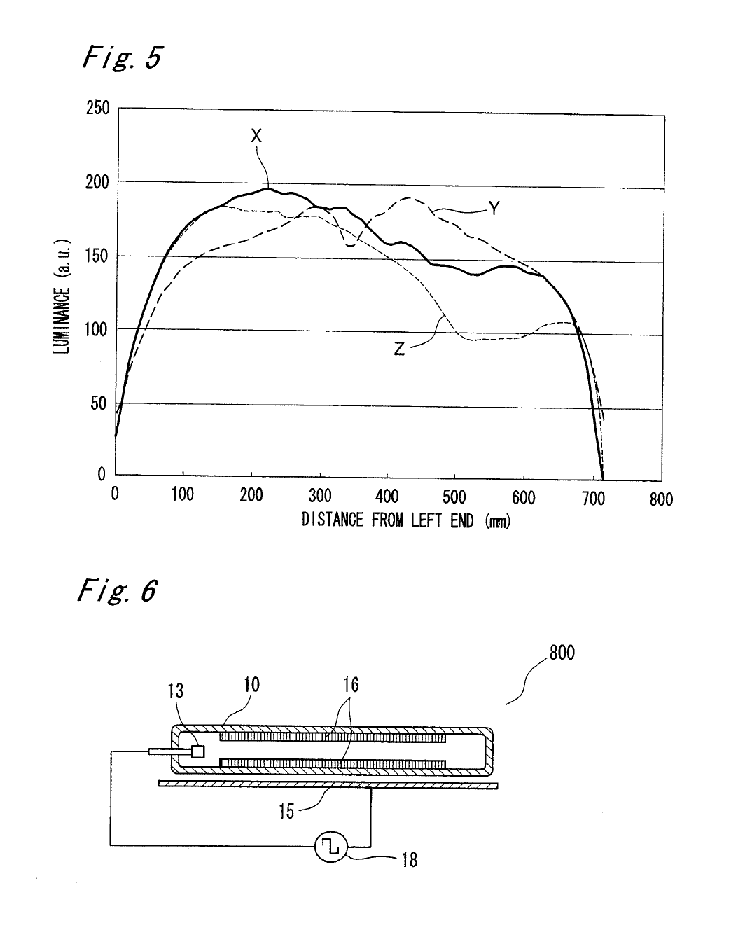

FIG. 5 shows measurements of luminance distribution in the dielectric barrier discharge lamp devices 100 and 300 shown in FIGS. 1 and 2. FIG. 5 also shows the luminance distribution of the dielectric barrier discharge lamp device 800 shown in FIG. 6 as comparative example. The dielectric barrier discharge lamp device 800 in FIG. 6 is different from the dielectric barrier discharge lamp device 100 of the invention in having an internal electrode 13 on only one end and no diode connected between the internal electrode 13 and ballast circuit 18.

In FIG. 5, a solid line X represents the luminance distribution of the dielectric barrier discharge lamp device 100 of the invention with the diode connected only to one internal electrode. A broken line Y denotes the luminance distribution of the dielectric barrier discharge lamp device 300 of FIG. 2A having internal electrodes on both ends with no diode connected to the internal electrodes. A broken line Z denotes the luminance distribution of the dielectric barrier discharge lamp device 800 of FIG. 6 having only one internal electrode to which no diode is connected.

Referring to FIG. 5, it is known that the luminance distribution of the conventional dielectric barrier discharge lamp device 300 (broken line Y) is balanced between right and left in the longitudinal direction. However, a recess (a dark spot) of luminance is recognized near the distance of 400 mm. This is because the discharge is repeated from the internal electrodes 13 and 13′ to the external electrode 15 or from the external electrode 15 to the internal electrode 13 and 13′ and thus the discharge from the internal electrodes 13 and 13′ is smaller near that distance.

By contrast, the luminance distribution of the dielectric barrier discharge lamp device 100 of the invention (solid line X) shows a more uniform luminance distribution without a recess (a dark spot) of luminance in the center, compared to the conventional dielectric barrier discharge lamp device 300 (broken line Y). According to the dielectric barrier discharge lamp device 100 of the invention, the luminance distribution is improved substantially compared to the conventional dielectric barrier discharge lamp device 800 having only one internal electrode (broken line Z). The reason of improvement of luminance distribution compared to the dielectric barrier discharge lamp device 800 is explained below.

In the dielectric barrier discharge lamp device 800 having only one internal electrode, since the discharge in a region of the glass tube 10 away from the internal electrode 13 is small, the luminance declines as going away from the internal electrode 13. On the other hand, in the dielectric barrier discharge lamp device 100 of the invention, when a reverse bias is applied to the diode 19, as shown in FIG. 1C, the discharge occurs from the external electrode 15 only to the internal electrode 13 to which no diode is connected. However, when a forward bias is applied to the diode 19, as shown in FIG. 1B, the discharge occurs from both internal electrodes 13 and 13′ to the external electrode 15. Therefore, the luminance distribution is improved more than the dielectric barrier discharge lamp device 800 having only one internal electrode, by increment of the discharge from the internal electrode 13′ to external electrode 15 in FIG. 1B.

Regarding the system efficiency, supposing the system efficiency of the dielectric barrier discharge lamp device 100 of the invention to be 1, it was 0.89 for the dielectric barrier discharge lamp device 800 having one electrode. Thus, it is also known that the system efficiency of the dielectric barrier discharge lamp device 100 of the invention is higher than that of the dielectric barrier discharge lamp device 800 having one electrode.

The lateral symmetrical property of luminance distribution in the dielectric barrier discharge lamp device 100 of the invention is inferior than that in the conventional dielectric barrier discharge lamp device 300. However, the lateral symmetrical property of luminance distribution can be improved easily by properly setting characteristic of a diffusion plate, or properly adjusting a voltage applied to the internal electrodes 13 and 13′.

Hence according to the dielectric barrier discharge lamp device 100 of the invention, when the lamp voltage from the ballast circuit 18 applied between the internal electrode 13′ and external electrode 15 is in a forward direction of the diode 19, the lamp current flows from the both internal electrodes 13 and 13′ toward the external electrode 15. Thus, uniformity of luminance in the axial direction of the glass tube 10 can be reduced more as compared with the dielectric barrier discharge lamp device 800 having only one internal electrode 13 with no diode 19 connected between the internal electrode 13 and ballast circuit 18.

5. Conclusion

As described above, the dielectric barrier discharge lamp device of the invention is arranged so that a diode is connected to only one electrode of a pair of internal electrodes disposed at both ends of the inside of a lamp and a voltage is applied from a ballast circuit through the diode. According to this arrangement, a uniform luminance distribution is realized, and the starting performance of the lamp lighting operation can be enhanced. It is noted that the dielectric barrier discharge lamp device 100 of the invention is used for a backlight for liquid crystal display, indoor illumination, backlight for signboard, or so on.

### INDUSTRIAL APPLICABILITY

The invention can improve starting performance of lamp lighting and realize a uniform luminance distribution, and hence it is applicable in backlight for liquid crystal display, indoor lighting, backlight for signboard, and so on.

The invention is described herein by referring to specified embodiments, but may be freely changed and modified within the scope of the invention by those skilled in the art. The invention is hence not limited to the illustrated embodiments alone, but may be limited to the scope of the claims appended herein. This application is related to the Japanese Patent Application No. 2006-034814 (filed on Feb. 13, 2006), the entire contents of which are incorporated herein by reference.

1. A dielectric barrier discharge lamp device comprising:
a glass tube filled with a discharge medium;
a pair of internal electrodes disposed at both ends of the inside of the glass tube;
an external electrode disposed outside of the glass tube;
a ballast circuit connected to the pair of internal electrodes and the external electrode; and
a diode connected between either one of the pair of internal electrodes and the ballast circuit.

2. The dielectric barrier discharge lamp device according to claim 1, wherein the discharge medium is a rare gas and includes no mercury.

3. A backlight for a liquid crystal display comprising:
a glass tube filled with a discharge medium;
a pair of internal electrodes disposed at both ends of the inside of the glass tube;
an external electrode disposed outside of the glass tube;
a ballast circuit connected to the pair of internal electrodes and the external electrode; and
a diode connected between either one of the pair of internal electrodes and the ballast circuit.
